(19) United States
(12) Patent Application Publication
(10) Pub. No.: US 2007/0189724 A1
(43) Pub. Date: Aug. 16, 2007

(54) Subtitle translation engine

(76) Inventors: Kang Wan, Beijing (CN); Zhi Jie Jie Liu, Beijing (CN)

Correspondence Address: CREATIVE LABS, INC.;LEGAL DEPARTMENT, 1901 MCCARTHY BLVD, MILPITAS, CA, 95035, US

(21) Appl. No.: 11/568,904

(22) PCT Filed: May 12, 2005
(86) PCT No.: PCT/SG05/00148

§ 371 Date: Nov. 9, 2006

(30) Foreign Application Priority Data
May 14, 2004 (CN) 200410038308.1

(51) Int. Cl. H04N 7/00; H04N 5/91

(52) U.S. Cl. 386/96

(57) ABSTRACT

A subtitle translation engine (20) for translating subtitle content from a video source to another language, the engine (20) comprising: a subtitle extractor (21) for extracting subtitle content in a first language from the video source; and a translation module (22) for translating words of the extracted subtitle content in the first language to a second language with the same meaning by performing a lookup on a language dictionary; where, during playback of the video, the extracted subtitle content is output in the second language.

### TECHNICAL FIELD

The present invention concerns a subtitle translation engine.

### BACKGROUND OF THE INVENTION

Modern electronic systems such as video playback machines and computers often employ Compact Disk Read-Only Memory (CDROM) media or DVD media for storing large amounts of data such as video or audio data. In the remainder of this specification, the acronyms CDROM and DVD will be grouped together, and commonly referred to as DVDs, since the subject matter of this disclosure applies equally to both types of systems.

DVDs are a popular alternative to video cassette tapes. One specific advantage a DVD has over a video cassette tape is that it allows subtitles to be turned on or off during playback. Also, a DVD may have up to 32 subpicture streams that overlay the subtitles in a movie. However, some languages are not be available on the DVD because the movie studio has neglected to make them. This means that consumers in certain countries are deprived from fully appreciating the movie in their native language. Alternatively, consumers attempt to understand a movie in a foreign language.

DVD movies are stored in Video Objects files (VOB files) in a subdirectory labelled “VIDEO₁₃ TS” on the DVD disc. A VOB file is a basic MPEG-2 system stream. Each VOB file is a file that contains multiplexed MPEG-2 video, audio and subpicture (SPC) streams. VOB files usually contain multiplexed Dolby Digital audio and MPEG-2 video.

Subtitles are encoded directly into the DVD bitstream itself and are usually selected for display by a user from the DVD menu, in contrast to Closed Captions which require an outboard decoder. There are two kinds of hard-encoded subtitles, open and closed. Open subtitles are presented without choice. That is, subtitles appear onscreen and cannot be defeated by turning off the subtitle option in a DVD player. In contrast, closed subtitles can turned on or off via the DVD menu or remote control device and are therefore defeatable. Closed subtitles are utilized exclusively by most DVDs and some Laser Discs.

SPC streams found in VOB files typically correspond to the subtitles of a movie. An SPC stream is a formatted MPEG stream that holds compressed subtitle bit streams. An SPC stream contains Presentation Stamps (PTS), and stream identification and sub-stream identification, similar to an audio stream. During final multiplexing, the SPC stream is merged with video and audio streams, to form a new VOB stream. SPC streams overlay on top of the main video stream (the movie), and can be turned on or off.

DVD subtitles are not recorded into the visible part of the TV picture but are stored as separate video strips, images or picture files in the SPC stream. These images are blended into the movie on playback. The advantage is that a DVD player does not need a character generator to render the images. Also, the text of the subtitle always remains in the same format as the publisher intended. The disadvantage is that these images slightly take up more space than plain text files. During playback with subtitles on, the DVD player reads and decodes the subtitles from the SPC stream and overlays the subtitles over the TV picture.

### SUMMARY OF THE INVENTION

In a first preferred aspect, there is provided a subtitle translation engine for translating subtitle content from a video source to another language, the engine comprising:

a subtitle extractor for extracting subtitle content in a first language from the video source; and

a translation module for translating words of the extracted subtitle content in the first language to a second language with the same meaning by performing a lookup on a language dictionary; where, during playback of the video, the extracted subtitle content is output in the second language.

The video source may be in Digital Versatile Disc (DVD), Super Video CD (SVCD) format, or any other format where video content and subtitles are stored as separate entities.

The language dictionary may be a lookup table or database. The language dictionary may be updated. The language dictionary may be used for translation between more than two languages. The engine may provide a user interface to allow selection of the second language.

The subtitle extractor may comprise an Optical Character Recognition (OCR) engine to convert subtitle content in image format into text format.

The translation module may translate words on a word-by-word basis or on a phrase-by-phrase basis. Advantageously, translation becomes more accurate as more words are translated in context rather than in isolation.

The first language may be English, French, Spanish, Italian or German. The second language may be Chinese (traditional or simplified characters), Japanese, Korean, Thai, Russian or Arabic.

The subtitle translation engine may be provided as a standalone unit, and be connected to a DVD player and television screen for input and output, respectively.

The subtitle translation engine may be provided within a DVD player or as software on a standard desktop computer.

The subtitle translation engine may further comprise a picture format determination module to determine the video format of the video source.

In a second aspect, there is provided a method for translating subtitle content from a video source to another language, the method comprising the steps of: extracting subtitle content in a first language from the video source; and translating words of the extracted subtitle content in the first language to a second language with the same meaning by performing a lookup on a language dictionary; where, during playback of the video, the extracted subtitle content is output in the second language.

In a third aspect, there is provided a computer program product comprised of a computer-readable medium for carrying computer-executable instructions for performing the method described.

In a fourth aspect, there is provided a translated subtitle stream when generated by the method described.

In a fifth aspect, there is provided a video stream comprising an MPEG-2 video stream multiplexed with the translated subtitle stream described.

### BRIEF DESCRIPTION OF THE DRAWING

An example of the invention will now be described with reference to the accompanying drawings, in which:

FIG. 1 is a block diagram of a home entertainment system incorporating a subtitle translation engine according to the present invention; and

FIG. 2 is a process flow diagram of translating subtitle content from a video source to another language.

### DETAILED DESCRIPTION OF THE DRAWING

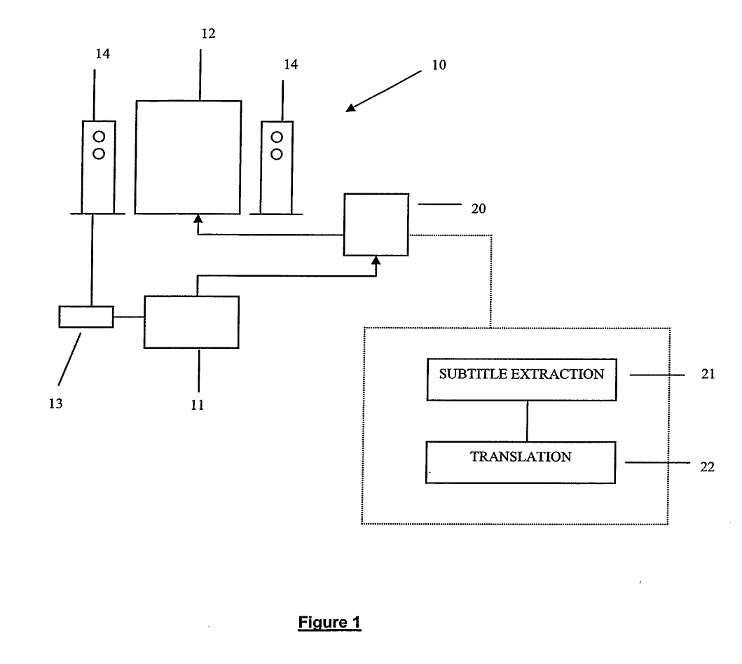

Referring to FIG. 1, a subtitle translation engine 20 is a standalone unit 20 incorporated in a typical home entertainment system 10. The subtitle translation engine 20 translates subtitle content from a DVD movie to another language unavailable on the DVD. The home entertainment system 10 comprises a DVD player 11, a display unit such as a television or monitor 12, hi-fi unit 13 and speakers 14. The subtitle translation engine 20 is connected to an output of the DVD player 11 and an input of the television 12.

The subtitle translation engine 20 includes a subtitle extraction module 21 and a translation module 22. A picture format detector (not shown) is also provided to initially determine whether the video format is DVD or another video format compatible for translation.

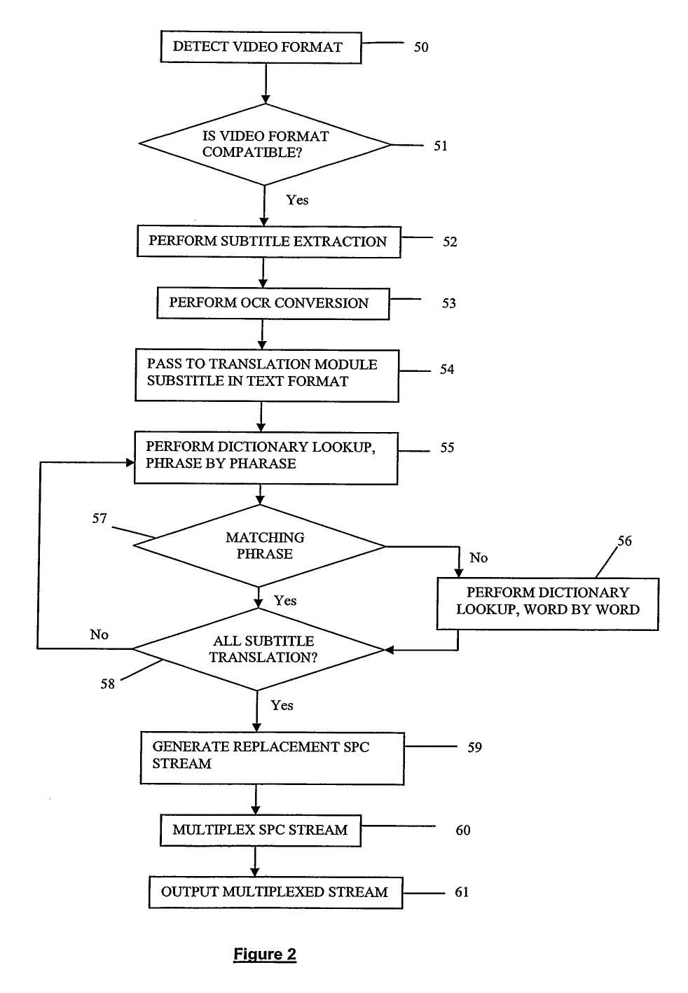

Referring to FIG. 2, after a compatible video format has been detected 51, the subtitle extraction module 21 extracts 52 subtitle content in a first language, for example, English, from the DVD. Subtitles are extracted from the SPC stream of the DVD player 11 before it is multiplexed with the video and audio streams, and captured by the subtitle extraction module 21. Alternatively, the video output of the DVD player is demultiplexed into its constituent streams, and the SPC stream is captured by the subtitle extraction module 21. The subtitle extraction module 21 has an Optical Character Recognition (OCR) engine (not shown) to convert 53 subtitle content in image format into text format, that is, to convert text embedded in an image into ASCII text. Once OCR is performed, and the extracted subtitles are in text format, they are passed 54 to the translation module 22 for translating the English subtitles to a second language, for example, Chinese with the same meaning. To improve the OCR process, various subtitle display styles are pre-defined and pre-trained OCR routines incorporated into the OCR engine.

In the translation module 22, a lookup is performed on a language dictionary using the English subtitle text as input. In this example, the dictionary (not shown) is an electronic English-Chinese dictionary and contains word for word translation 56 as well as phrase to phrase translation 55. If a phrase in English does not yield a positive match 57 in the dictionary for a Chinese equivalent, a word for word translation is performed on the phrase. The English subtitle is progressively translated to Chinese until all possible English words with a Chinese equivalent have been translated 58. The dictionary can be user updated or replaced if a newer version becomes available. The dictionary is upgraded via Internet download or from an installable CD-ROM disc. A central copy of the dictionary, for example, on the Internet, can be contributed to and maintained by a group of people to improve its accuracy or increase the phrase to phrase capability of the dictionary.

After the Chinese subtitle has been generated from the English subtitle, a replacement SPC stream is generated 59 to be multiplexed 60 with the video stream, and output 61 to the video input of the television 12. During playback of the movie, the extracted subtitle content is output in Chinese with little or no latency from the subtitle translation process. The process repeats itself for the next subtitle extracted by the subtitle translation engine 20.

The translation of subtitles from one language to another not present on the DVD is seamless and transparent to the user after they select the language of the subtitle for display.

The present invention is applicable to SVCDs. The SVCD video format overlays graphics for subtitles. An SVCD video stream contains up to four independent subtitling channels for different languages. The subtitles are overlaid on the top of the video image in real time and are provided on an independent track, they can be turned on and off, on demand.

Although the present invention has been described with reference to the DVD and SVCD format, it is envisaged that other video formats where video content and subtitles are stored separately is possible.

Although the present invention has been described with reference to a standalone unit 20, it is envisaged that a standard computer installed with software to perform the method of translation described is possible. It is also envisaged that a standard DVD player may be modified to perform the method of translation described.

It will be appreciated by persons skilled in the art that numerous variations and/or modifications may be made to the invention as shown in the specific embodiments without departing from the scope or spirit of the invention as broadly described.

The present embodiments are, therefore, to be considered in all respects illustrative and not restrictive.

The claims defining the invention are as follows:

1. A subtitle translation engine for translating subtitle content from a video source to another language, the engine comprising:
a subtitle extractor for extracting subtitle content in a first language from the video source; and
a translation module for translating words of the extracted subtitle content in the first language to a second language with the same meaning by performing a lookup on a language dictionary;
where, during playback of the video, the extracted subtitle content is output in the second language.

2. The engine according to claim 1, wherein the video source is in Digital Versatile Disc (DVD), Super Video CD (SVCD) format, or any format where video content and subtitles are stored as separate entities.

3. The engine according to claim 1, wherein the language dictionary is one of a lookup table, and database.

4. The engine according to claim 3, wherein the language dictionary is able to be updated.

5. The engine according to claim 3, wherein the language dictionary is used for translation between more than two languages.

6. The engine according to claim 1, wherein the subtitle extractor comprises an Optical Character Recognition (OCR) engine to convert subtitle content in image format into text format.

7. The engine according to claim 1, wherein the translation module translates words on a word-by-word basis or on a phrase-by-phrase basis.

8. The engine according to claim 1, wherein the first language is any one of English, French, Spanish, Italian or German.

9. The engine according to claim 1, wherein the second language is any one of Chinese (traditional or simplified characters), Japanese, Korean, Thai, Russian or Arabic.

10. The engine according to claim 1, wherein the subtitle translation engine is a standalone unit, for connection with a DVD player and television screen for input and output, respectively.

11. The engine according to any one of claims 1 to 9, wherein the subtitle translation engine is incorporated within a DVD player.

12. The engine according to any one of claims 1 to 9, wherein the subtitle translation engine is a software program to be installed on a computer.

13. The engine according to claim 1, further comprising a picture format determination module to determine the video format of the video source.

14. A method for translating subtitle content from a video source to another language, the method comprising the steps of:
extracting subtitle content in a first language from the video source; and translating words of the extracted subtitle content in the first language to a second language with the same meaning by performing a lookup on a language dictionary;
where, during playback of the video, the extracted subtitle content is output in the second language.

15. The method according to claim 14, comprising an initial step of detecting the video format of the video source to determine whether the video source is compatible for translation.

16. The method according to claim 14, wherein the video source is in Digital Versatile Disc (DVD), Super Video CD (SVCD) format, or any format where video content and subtitles are stored as separate entities.

17. The method according to claim 14, wherein the language dictionary is one of a lookup table, and database.

18. The method according to claim 17, wherein the language dictionary is able to be updated.

19. The method according to claim 17, wherein the language dictionary is used for translation between more than two languages.

20. The method according to claim 14, wherein an Optical Character Recognition (OCR) engine is provided to convert subtitle content in image format into text format.

21. The method according to claim 14, wherein the words of the extracted subtitle content are translated on a word-by-word basis or on a phrase-by-phrase basis.

22. The method according to claim 14, wherein the first language is any one of English, French, Spanish, Italian or German.

23. The method according to claim 14, wherein the second language is any one of Chinese (traditional or simplified characters), Japanese, Korean, Thai, Russian or Arabic.

24. A computer program product comprised of a computer-readable medium for carrying computer-executable instructions for performing the method according to claim 14.

25. A translated subtitle stream generated by the method according to claim 14.

26. A video stream comprising an MPEG-2 video stream multiplexed with a translated subtitle stream according to claim 25.
